(19) United States
(12) Patent Application Publication
(10) Pub. No.: US 2009/0145992 A1
(43) Pub. Date: Jun. 11, 2009

(54) Sanitary door handle

(76) Inventor: Meron Lavy, London (GB)

Correspondence Address: DR. MERON LAVY, P.O.BOX 3023, MARKET PLACE, LONDON, N2 0HR, GB

(21) Appl. No.: 12/313,282

(22) Filed: Nov. 19, 2008

(30) Foreign Application Priority Data
Dec. 7, 2007 (GB) GB0724045.0

(51) Int. Cl. E05B 1/00

(52) U.S. Cl. 242/364.11

(57) ABSTRACT

This invention relates to a flat sanitary door handle mechanism incorporating a self-contained mechanical user-operated continuous material advancing system whereby the person touches a fresh length of material while using the flat door handle to open the door thus avoiding hand exposure to the surface of the flat handle which may have been contaminated by previous users. This is achieved by the pull and release of the flat door handle by the user, without any external source of power, the action of which replaces the used length of material with a fresh length and makes the handle ready for use by the next person.

### BACKGROUND OF THE INVENTION

This invention relates to a sanitary door handle whereby a manual user-operated mechanical advancing mechanism replaces position of a continuous thin paper/film on the handle thus user hands do not come into contact with potentially contaminated area touched by previous users.

Contaminated door handles have been a source of transfer of bacteria, germs and potential diseases, especially in areas of high human traffic such as public toilets, hospitals and restaurants to name a few. Most public toilet doors open inwards for safety reason, therefore the person entering the room does not necessarily have to touch any surface, and however the person exiting the room has to pull on a handle to open the door. A door, which can only open in one direction, cannot be opened without a handle and therefore it becomes contaminated by the users and human-to-human transfer of germs and diseases is inevitable.

Several designs for sanitary door handles, gloves and tissues for handling potentially contaminated door handles have been proposed over the years. For example application number GB2418857 by Wyen George James introduces a door handle, which sprays disinfectant on the door handle as it is operated on and claims to improve personal and public hygiene. However, this relies on a mechanism to spray the liquid on the surface of the handle, which may leave an undesirable as well as unexpectedly wet surface for the next user. The spray methodology cannot remove filth or other undesirable sediment from the surface left by users.

Davis Trevor Charles Edward (application number GB2387542) proposes a transparent handle incorporating a switch whereby an ultraviolet light is shined from within it and hence sterilises the surface. It requires external power to illuminate the UV light. And, again it has the drawbacks of the previous invention mentioned and its effectiveness is questionable.

Application number U.S. Pat. No. 6,789,695 by G Benjamin presents a door handle, which is covered by a dispensable tissue—the tissue is dispensed from the hanging holdall on the door and covers the door handle. The user pulls a fresh tissue, which acts as a barrier between the hand and the handle and once the door is opened discards the tissue in a small receptacle or bin. This system relies only on proper use, is over-simplified and the holdall may not accommodate all the discarded tissues.

Application number U.S. Pat. No. 6,289,557 by Manson Barry F et al is a handle bar in the form of a loop. It is claimed the user can operate it with the wrist or forearm. It appears to be a bulky handle bar and its safety is questionable in high traffic public places so is its ease of usage and safety when handled by untrained passing persons as well as the disabled.

With regards to the state of the art and relevance to the present invention, Hawkins F (U.S. Pat. No. 4,658,469) filed an application for a door handle, which incorporates a material advancing system activated by a sensor detecting approaching hands. The mechanism is motorized using batteries as a source of power. It appears to be a very elaborate system with not-so-easily replaceable paper reels and some other drawbacks; the paper whilst in use does not cover the whole of the handle leaving some area exposed to hands hence defying its objective.

The patent application by Muderlack et al (US2007/0241125 A1) presents a door handle material advancing system that has the versatility that, when mounted on a door, its handle can be grasped and used in different aspects. It is also claimed to have a dual-use handle sanitary cover refill cartridge for supplying and collecting used material to aide loading of such a cartridge inside the handle's casing. However, on close inspection of the patent description it appears that complications related to loading of the sanitary covered handle relay onto the main handle core still remain. Although extensively described and illustrated in this application, it's unclear as to how the cover material or the said handle relay, when in place, can cover the majority of the handle area grasped by hand. Furthermore, the proposed system adopts a rather elaborate sensor-activated motorized handle cover advancing and cover material metering device. The system has the advantages noted above but it is believed that from the maintenance, practical and logistical point of view it's usage may be limited.

### SUMMARY OF THE PRESENT INVENTION

The objective of this invention is to introduce a door handle mechanism of simple construction and requiring minimum maintenance whereby each time the handle is pulled to open the door and released, a fresh length of paper/film (which essentially acts as a barrier between the hand of the user and the door handle) replaces the one used by the previous user, hence the next user's hand will be exposed to a fresh barrier paper/film and not the handle bar itself. In this way, the spread of bacteria, germs and potential diseases between users will be minimised. The self-contained continuous material mechanical advancing mechanism is manually activated by the user's pull and release of the handle hence eliminating the need to use any electrical motorization and source of power. It is hoped that this invention will find viable market in public toilets, hospitals, restaurants, or other places for opening and closing of doors and cabinet doors where sanitary consideration is of importance.

### BRIEF DESCRIPTION OF THE DRAWINGS

FIG. 1 OVERALL VIEW OF THE FLAT DOOR HANDLE AND ITS CASING

FIG. 2 DETAILED EXPLODED PERSPECTIVE VIEW OF THE FLAT DOOR HANDLE MECHANISM

FIG. 3 DETAILED BASE PLAN VIEW OF THE FLAT HANDLE AND THE ADVANCING COMPONENTS

FIG. 4 DETAILED PLAN VIEW OF THE FLAT HANDLE, SPOOLS, HAND SHIELDS AND THE COMPONENTS

FIG. 5 DETAILED SIDE VIEW OF THE SPOOL DANCING MECHANISM

### DESCRIPTION OF THE PREFERRED EMBODIMENT

The invention is now described in detail with reference to the accompanying figures.

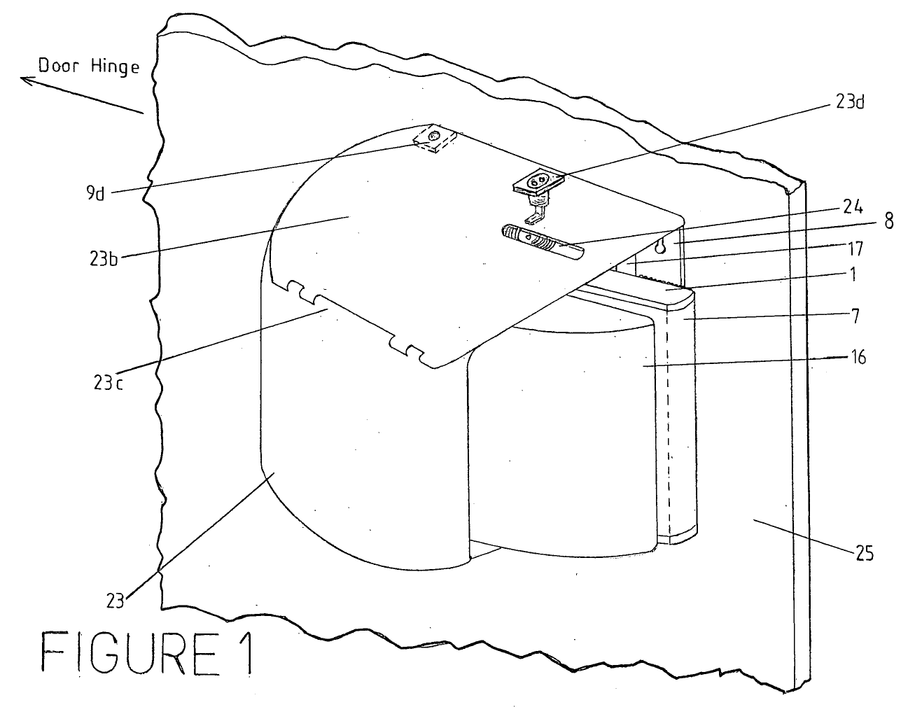

Referring to FIG. 1, the mechanism consists of a flat door handle bar (1) that is covered by a length of paper/film (7) from the reel in the area most likely to be touched by the user's hand. When the user touches the handle, the paper/film acts as a barrier between the hand and the flat door handle. When the user pulls the handle to open door (outwards from paper on the drawing), the force will open the door (25), which is partly shown here. The user releases the door handle and exits. The door handle moves back to its original position and whilst doing so, a fresh length of paper/film is dispensed from the feed reel and replaces the one used and makes the handle ready for the next user.

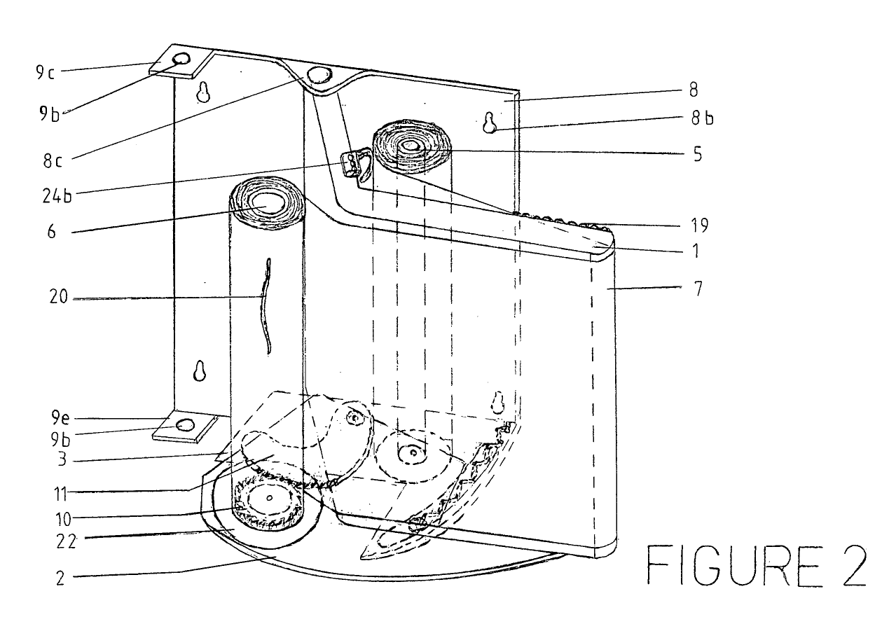

With reference to perspective view in FIG. 2 and FIG. 1, the mechanism consists of a flat door handle (1) that is a formed thin plate or of solid construction with at least one flat side. This shape of handle that is shown by way of example and is not limited to, is to create an ergonomic surface for hand contact and for paper/film to run over it. The handle (1) is attached onto a base (2) that is in turn mounted such as to pivot on a flange (3) and flange (8c) both of which are part of the mounting bracket (8). There is a feed spool (5) that holds a reel of thin non-absorbing biodegradable paper/film (7), and a take-up spool (6) that is of a different diameter to (5) for the reasons explained later. The mechanism is attached to door mounting bracket (8) that can be mounted on the door via bolt holes (8b). A casing labelled (23) in FIG. 1, slides over the mechanism and, with the exception of the protruded part of the handle and hand shield, conceals the components within it. Bracket (9d) on the edge of the casing fits over bracket (9c) and secures it via bolt fitted through hole (9b) to the door mounting bracket (8). Similarly, brackets (9e) secure the casing to the door bracket at the bottom. With the casing in position, only part protruded handle bar and hand shield are exposed for use. The casing's top panel (23b), which is hinged (23c) to the front of the casing, acts as an access port for the internally mounted spools and will be described later. This hinged panel is secured and locked to the mounting bracket flange (8c) by a camlock (23d).

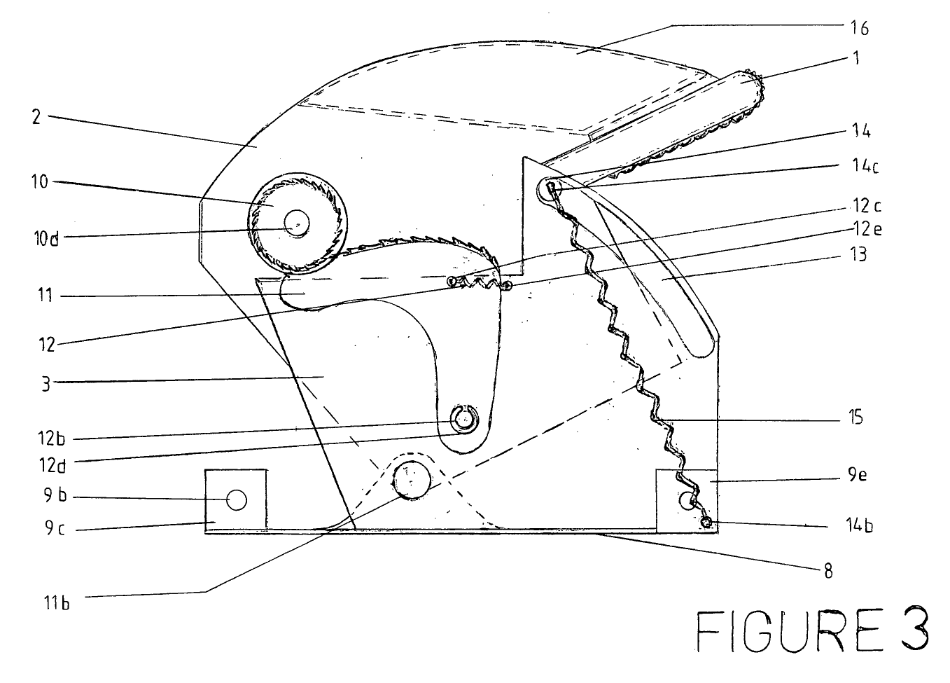

FIG. 3 shows the base view of the mechanism. Gear (10), whose teeth have large pressure angles, is part of the take-up spool (6), which runs on a ratchet gear lever (11) whose teeth have similar pressure angles as gear (10). The ratchet gear (11) is pushed against gear (10) by the tension in extension spring (12). The ratchet gear lever (11) is pivoted on the stud (12b) and is held in position by a retaining ring (12d) and can move freely about the axis of the stud. Peg (12e) restricts the movement of the ratchet lever and ensures correct engagement between the gears. The loop on extension spring (12) is hooked onto the recess on peg (12e) and its other end's loop is hooked onto the recess on pin (12c). The base-handle assembly (1) and (2) can move relative to the fixed flange (3) and is always in tension being pulled towards the mounting bracket (i.e. door) by the extension spring (15). This spring is hooked by its loop onto recess on pin (14b) on the flange and its other end's loop is hooked onto recess on pin (14c) on stud (14). The stud (14) can slide within slot (13) along flange (3) only through a predetermined subtended angle. This angle in turn determines the subtended angle through which the handle bar can travel back and forth and the stud (14) restricts the handle's movement through the set angle. When the handle is pulled, it comes to a dead stop in forward position after which any further force by hand will open the door. Upon release of the handle bar, it returns to its original resting (or backward) position by the tension in the spring.

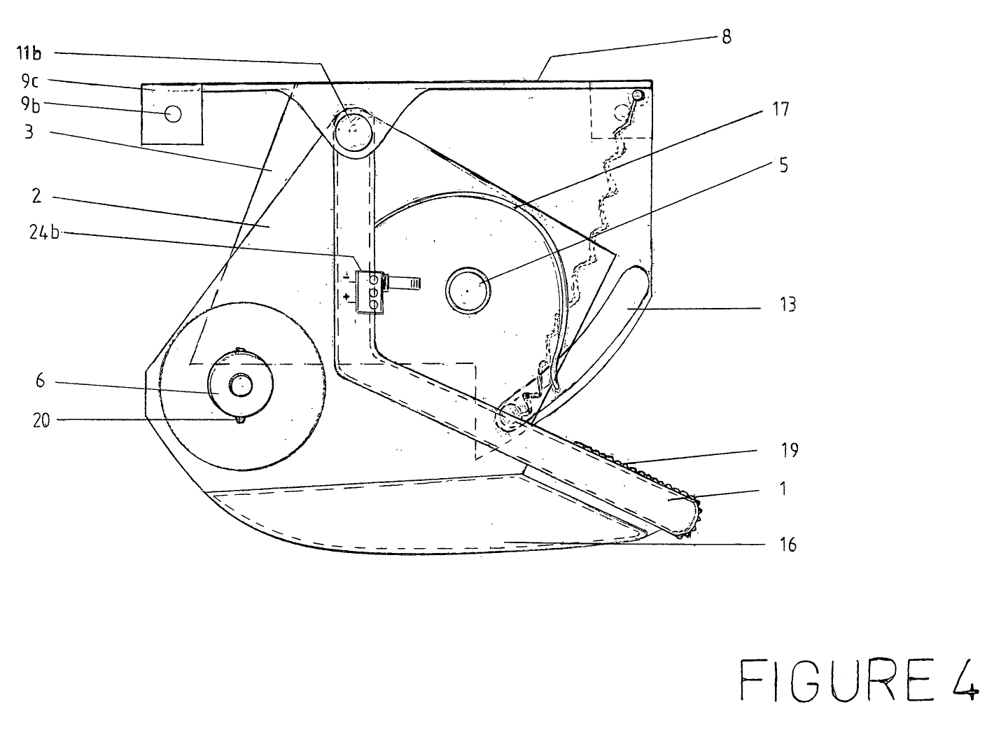

FIG. 4 shows the mechanism's plan view. The hand/fingers non-trap shield (16) is a formed thin plate whose shape is shown by way of example and is not limited to, and is attached to the base plate (2). As the name implies it protects the user's hand and fingers from coming into contact with the take-up spool (6) and the mechanism inside and guides user's hand to grasp onto the correct part for operating the handle. This will be explained more extensively later. The cylindrical shaped thin plate hand/fingers non-trap shield (17) is a similar protector whose shape is shown by way of example but is not limited to, and is attached to the base plate (2). It protects user's hands and fingers from coming into contact with the spool (5) and the components to the rear of the mechanism. Friction strip (19) is a width of grated metal or abrasive material of high frictional characteristic that is integrated along the edge of the flat handle bar (1) in the area most likely to be grasped by hand; its purpose is to create a non-slip surface between the paper/film and the flat handle bar while the user pulls or pushes against the paper/film hence preventing slack in the paper/film.

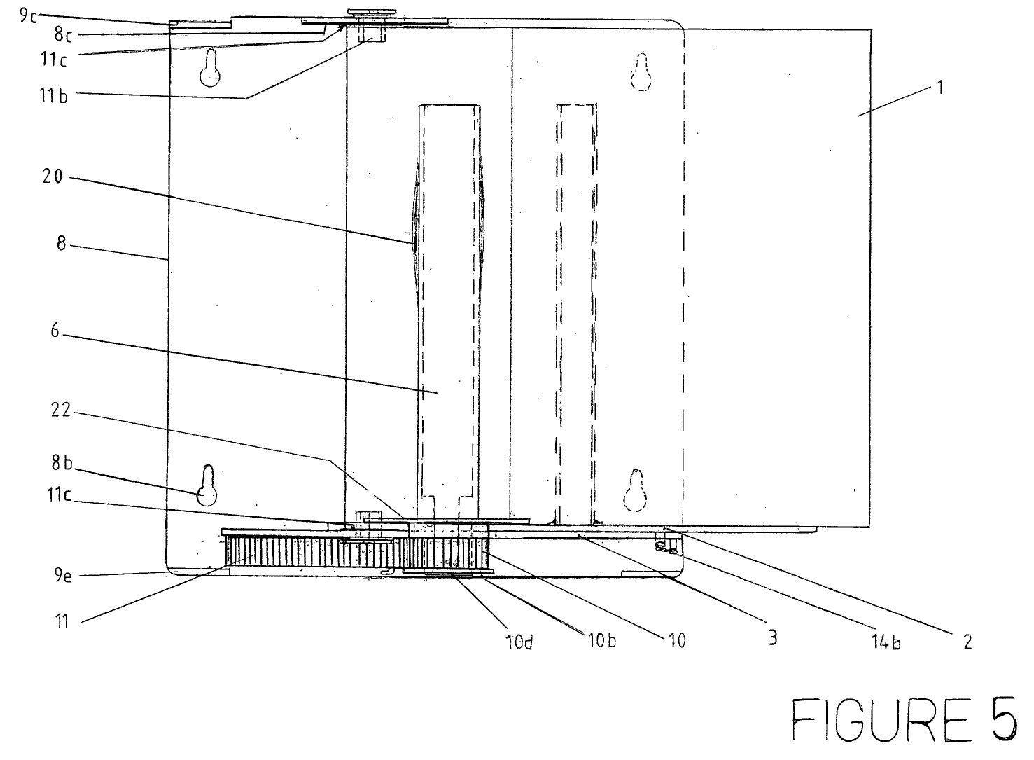

FIG. 5 shows the side view of the take-up spool mechanism. Flat door handle (1) is attached to the base plate (2) and, for extra strength, is pivoted on flange (3) and bracket flange (8c). For smooth rotation of the handle bar, slide bearings (11b) or similar bearings are used at the pivots. Washers (11c) placed between the handle bar and flanges ensure frictionless movement between the components. Take-up spool (6) that has thin inner wall is attached on a frictionless disc (22) that rests on the base plate (2) and is attached by interference fit to the gear (10) via protruded part of the spool (10d). The spool has a gradual sloppy protrusion (20) along about half of its height on each side that form a grip when the paper/film reel is loaded onto the spool. The presence of disc (22) also reduces the effect of cantilevering on the spool when the film/paper is under tension. Disc (10b) that is integral part of gear (10) prevents ratchet gear (11) from twisting whilst meshing with gear (10) and under load. This forms an assembly that rotates smoothly and freely. The feed spool (5) that has thin inner wall is permanently attached to the base plate (2) and excludes the features noted for the take-up spool (6). The paper/film reel can rotate freely on the feed spool.

The operation of the handle bar is now described in more detail. Referring to FIGS. 1, 3 and 4, the paper/film reels consist of a feed reel with a length of the paper/film already attached to the blank take-up reel. The reels, which have different diameters (to avoid confusing one with the other when loading them), are initially dropped onto the appropriate take-up and feed spools (6 and 5). The paper/film is directed along the handle bar (1) and through the small gap between the handle bar and hand shield (16). To assist with loading, a short initial length of paper/film reel is made of thick material. The casing's access port (23b), which is essentially a lid hinged to the front top of the casing is now closed and locked onto the mounting bracket by camlock (23d). To operate the mechanism, the user pulls on the flat handle bar (1) till it reaches the dead stop (or forward) position (this is about 30 to 40 degrees subtended angular movement on the handle bar which provides enough displacement of the paper/film in the area likely to be grasped by hand). During this action gear (10) pushes against ratchet lever (11) while moving but does not rotate because it does not engage with the latter; further pull on the handle will open the door, the user releases the handle bar and exits. The handle is spring loaded and returns to its original resting (backward) position, and during this movement gear (10) and ratchet lever (11) are engaged and the former's rotation (which is due to the handle returning to its resting position) forces the take-up spool (6) holding the take-up reel to rotate by a certain angle; this action consequently pulls a fresh length of paper/film from the feed reel on spool (5) and replaces the length of paper/film touched by the user, which is wound onto the take-up reel. The handle is now ready for the next user. The significance of the hand/fingers non-trap shields (16 and 17) now become apparent—they act as protection for hands and fingers from coming into contact with the paper/film reels and the mechanism inside; moreover, hand/fingers non-trap shield (16) ensures that the user grasps on the sanitary handle bar and not other protruding part(s) of the mechanism. Because of the design of the handle and its protruding part, any water/liquid remaining on the user's hand while touching the handle will drain downwards and away from the mechanism and through the casing's bottom opening.

Aperture (24) that is situated on the casing's access port (shown in FIG. 1) is used to inspect the amount of paper/film used or left on the reels, and can have graduation marks on the side so as to indicate when replacement of paper/film reel becomes necessary. Furthermore, markings on the final length of the paper/film being unrolled from the feed reel will be an indication of nearing the end of the paper/film on the feed reel. An additional mechanical switch (24b) with an arm lever can be attached to the handle bar near the feed spool (see FIG. 2). This switch is connected to a simple circuit consisting of a battery and a LED. The switch is normally open, but when the paper/film on the feed spool reaches near the end, the arm lever of the switch, which is lightly pressed against the paper/film, will close the circuit and hence illuminating the LED. The LED can be viewed through aperture (24) signalling the need to replace the reel. The paper/film reels can easily be replaced when needed in converse order to what has been described above.

With regards to the materials used for the construction of the parts, the internal components can be, but not limited to, single or mixture of metals and plastic-based materials depending on the strength and durability requirement. For example duracon or nylon can be used for the gears and spools. From aesthetic and hygiene point of view, the components exposed to hands such as the handle bar, hand/fingers shields and the outer casing can be constructed from stainless steel, chrome or high-grade aluminium or similar metals. The parts most likely to be vulnerable to any cross contamination by the used paper/film and hands can be coated with antimicrobial metallic material such as brass and silver that prevent bacteria growth. In all cases consideration will be given to the use of materials that will reduce overall weight. The paper/film used in reels can be of ultra-thin non-absorbing biodegradable high-density polyethylene or similar material.

It should be mentioned that for it to function correctly and from ergonomics point of view, the mechanism, as shown on the foregoing figures, is suitable for a door with hinge(s) located to the left of the handle. However, the mechanism can be mounted on a door as shown but having been rotated clockwise by ninety degrees, without impeding its internal operation. If mounted in this position, the handle bar is pulled from below (i.e. about a horizontal axis as opposed to from the side). In a different embodiment, the mechanism can be manufactured so the components are assembled in a mirror-like manner to what has been described herein and shown in the figures, which can suit mounting the handle on a right-hinged door.

The described door handle mechanism will be suitable for most doors used in practice. However, because the door handle advancing mechanism is spring loaded, the load resisting its action must be greater than that of the mechanism itself. Therefore, for the mechanism to operate properly, the door that the handle is to be fitted on should be loaded accordingly.

The invention described above is suitable for attachment onto a door without a latch. In a similar embodiment to that described in this invention, the mechanism can incorporate a simple link to a door latch lever so that the latch can be operated when the handle bar is pulled and released.

The aforementioned is the description of an invention for a flat sanitary door handle with a mechanical continuous paper/film advancing mechanism manually operated by the hand of the user without external source of power. The design of the invention is not limited thereto and can include additional features and modifications falling within the context and scope described in the claims.

1) A flat sanitary door handle mechanism having a mechanical continuous thin paper/film material advancing system manually activated by the user's pull and release of the flat handle; the paper/film effectively forming a barrier between user's hand and the flat handle so as to reduce transfer of bacteria, micro-organisms, germs and diseases between users; the mechanism, being mechanically operated, having two spools to hold the feed and take-up paper/film reels separately; each pull and release of the flat handle through a displacement angle mechanically rotating the take-up spool and consequently pulling a length of fresh paper/film from the feed reel and replacing the used paper/film on the area of the door handle which is touched by hand.

2) A flat sanitary door handle mechanism as per claim 1 wherein with material advancing mechanism whereby every pull and release of the flat handle through a set displacement will advance the paper/film by a predetermined length in the flat handle's hand contact area.

3) A flat sanitary door handle mechanism as per claim 1 wherein consisting of two spools, one to hold the feed paper/film reel and the other to hold the take-up paper/film reel.

4) A flat sanitary door handle mechanism as per claim 1 wherein having two hand/fingers non-trap shields to protect user's hand/fingers from coming into contact with the components and paper/film reels within the mechanism and to guide hand to the flat sanitary handle bar.

5) A flat sanitary door handle mechanism as per claim 1 wherein having a frictional strip along the edge of its handle to create a non-slip area between paper/film and the handle and to prevent paper/film slack when grasped by hand.

6) A flat sanitary door handle mechanism as per claim 1 wherein whose handle bar and other associated components are enclosed in a casing which together with the hand/fingers non-trap shields as per claim 4 wherein will form a system whereby only the useable part of the flat handle bar is exposed for grasp by hands.

7) A flat sanitary door handle mechanism as per claim 1 and claim 6 wherein with its casing containing an aperture thorough which the amount of paper/film used and/or remaining in the reels can be viewed for inspection.

8) A flat sanitary door handle mechanism as per claim 1 wherein and having paper/film reels as per claim 3 wherein, with markings on the final length of the paper/film to indicate nearing end of the paper/film reel.

9) A flat sanitary door handle mechanism as per claim 1 wherein having a door mounting plate that allows the mechanism to be mounted on doors such that the handle can operate either about the horizontal axis or vertical axis depending on the left-or right-hinged door configuration to be used and ease of operation desired.
